(19) United States
(12) Patent Application Publication
(10) Pub. No.: US 2012/0103970 A1
(43) Pub. Date: May 3, 2012

(54) HEATER WITH INDEPENDENT CENTER ZONE CONTROL

(75) Inventors: Dmitry Lubomirsky, Cupertino, CA (US); Sudhir R. Gondhalekar, Pleasanton, CA (US); Shankar Venkataraman, Santa Clara, CA (US); Kirby H. Floyd, San Jose, CA (US); Yizhen Zhang, Milpitas, CA (US)

(73) Assignee: Applied Materials, Inc., Santa Clara, CA (US)

(21) Appl. No.: 13/099,220

(22) Filed: May 2, 2011

Related U.S. Application Data
(60) Provisional application No. 61/334,386, filed on May 13, 2010.

(51) Int. Cl. H05B 3/74; H05B 3/02

(52) U.S. Cl. 219/460.1

(57) ABSTRACT

A substrate heater comprising a ceramic substrate support having a substantially flat upper surface for supporting a substrate during substrate processing; a resistive heater embedded within the substrate support; a heater shaft coupled to a back surface of the substrate support, the heater having an interior cavity that extends along its longitudinal axis and ends at a bottom central surface of the substrate support; and a supplemental heater, separate from the ceramic substrate support, positioned within the interior cavity of the heater shaft in thermal contact with a portion of the bottom central surface of the substrate support such that the supplemental heater can alter the temperature of a central area of the upper surface of the substrate support.

### CROSS-REFERENCES TO RELATED APPLICATIONS

This application claims the benefit of U.S. Provisional Patent Application No. 61/334,386, filed May 13, 2010, and entitled “HEATER WITH INDEPENDENT CENTER ZONE CONTROL,” which is incorporated herein by reference for all purposes.

### BACKGROUND OF THE INVENTION

The present invention relates generally to the field of substrate processing equipment. More specifically, the present invention relates to an apparatus and method for controlling the temperature of substrates, such as semiconductor substrates, used in the manufacture of integrated circuits.

Modern integrated circuits (ICs) contain millions of individual elements that are formed by patterning the materials, such as silicon, metal and/or dielectric layers, that make up the integrated circuit to sizes that are small fractions of a micrometer. Many of the steps associated with the fabrication of integrated circuits include precisely controlling the temperature of the semiconductor substrate upon which the ICs are formed.

One challenge semiconductor manufacturers face in such process steps is controlling the temperature of the substrate uniformly across the entire surface of the substrate. Even minor differences in temperature between various locations of the substrate may result in undesirable differences in physical characteristics of one or more of the layers formed at those locations on the substrate.

One type of heater that is particularly useful in high temperature substrate processing is a pedestal design that employs a ceramic substrate support. A resistive heating element is buried beneath the upper surface of the ceramic substrate support and an electrical feed for the resistive heater is positioned within a pedestal that attaches to the bottom of the heater and raises the substrate above the floor of the substrate processing chamber. FIG. 1 is an example of a previously known pedestal heater 2 that includes a ceramic substrate support 4 that is attached to a hollow stem or pedestal 6. Embedded within ceramic support 4 is an RF electrode 8 and a resistive heater 10. Electrical connector rods 12 and 14 provide power to RF electrode 8 and resistive heater 10, respectively. Some pedestals heaters also include a vacuum lines (not shown) that allow a substrate to be chucked to the pedestal by vacuum pressure.

The temperature control challenge discussed above often manifests itself for pedestal heaters, such as heater 2, in that the center of the substrate heater is slightly cooler than other parts of the heater. This is because electrical connections for the heater and an RF electrode are typically made near the center of the pedestal providing less area for the resistive heating element than is available in other areas of the heater.

Accordingly, while the substrate heater shown in FIG. 1 is useful for many substrate processing operations, new and improved substrate heaters and methods for accurately controlling substrate temperature are desired.

### BRIEF SUMMARY OF THE INVENTION

Some embodiments of the invention provide a substrate heater that includes two separately controllable heating systems including a first, primary heater embedded within a substantially flat upper surface of a substrate support and a second, supplemental heater positioned within a hollow pedestal coupled to a back surface of the substrate support. The primary heater can be, for example, a resistive heater embedded within the substrate support and laid out in a two-dimensional pattern covering a footprint of the support surface. The supplemental heater can be operatively coupled to the substrate support such that the supplemental heater can alter the temperature in a central area of the upper surface of the substrate support.

According to one embodiment of the invention, a substrate heater is provided that comprises a ceramic substrate support having a substantially flat upper surface for supporting a substrate during substrate processing. A resistive heater is embedded within the substrate support and a heater shaft is coupled to a back surface of the substrate support. The heater shaft can have an interior cavity that extends along its longitudinal axis and ends at a bottom central surface of the substrate support. The substrate heater may further include a supplemental heater, separate from the ceramic substrate support, positioned within the interior cavity of the heater shaft in thermal contact with a portion of the bottom central surface of the substrate support such that the supplemental heater can alter the temperature of a central area of the upper surface of the substrate support.

A substrate heater according to another embodiment comprises a ceramic substrate support having a substantially flat upper surface for supporting a substrate during substrate processing. A resistive heater is embedded within the substrate support and laid out in a two dimensional pattern that is adapted to heat the upper surface of the substrate support in a generally uniform manner, and a heater shaft is coupled to a back surface of the substrate support. The heater shaft includes an interior cavity that extends along its longitudinal axis and ends at a bottom central surface of the substrate support. A detachable supplemental heater is positioned within the cavity and an air gap surrounds the supplemental heater between an interior surface of the heater shaft that defines the cavity and an outer peripheral surface of the supplemental heater. A biasing mechanism is operatively coupled to force the supplemental heater in thermal contact with a portion of the bottom central surface of the substrate support such that the supplemental heater can alter the temperature of a central area of the upper surface of the substrate support.

Various benefits and advantages that can be achieved by these and other embodiments of the present invention are described in detail below in conjunction with the following drawings.

### BRIEF DESCRIPTION OF THE DRAWINGS

FIG. 1 is a simplified cross-sectional view of a substrate heater according to the prior art;

FIG. 2 is a simplified cross-sectional view of a substrate heater according to an embodiment of the invention;

FIG. 3 is a simplified perspective view of a substrate heater according to another embodiment of the present invention;

FIG. 4 is a simplified perspective view of a substrate heater according to still another embodiment of the present invention;

FIG. 5 is a simplified cross-sectional view of a substrate heater according to another embodiment of the present invention;

FIG. 6 is a simplified cross-sectional view of a substrate heater according to yet another embodiment of the present invention;

FIGS. 7A and 7B are simplified cross-sectional views of a heater shaft according to different embodiments of the invention; and

FIGS. 8 and 9 depict test results demonstrating the effectiveness of the invention as compared to previously known substrate heaters.

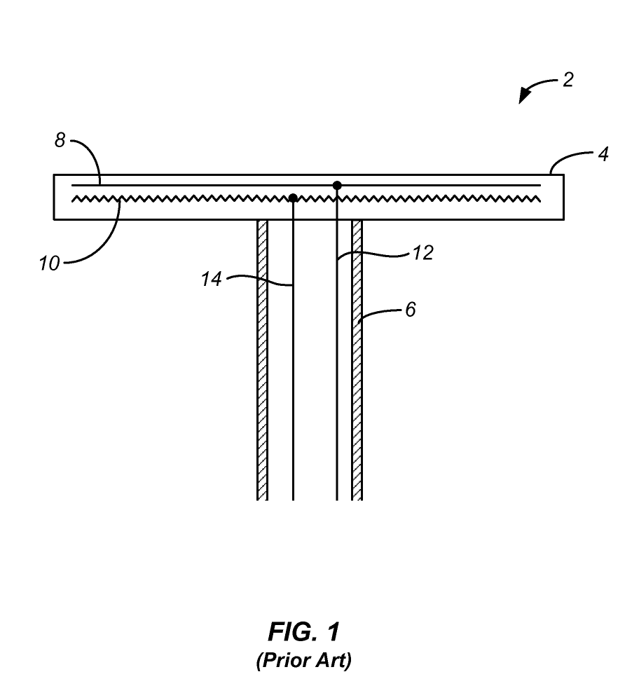

### DETAILED DESCRIPTION OF THE INVENTION

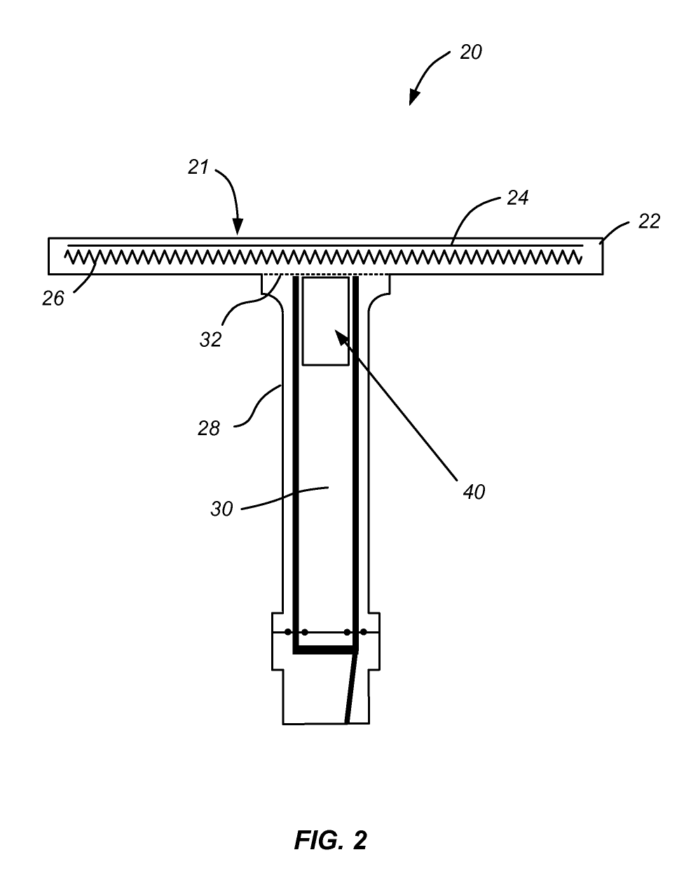

FIG. 2 is a simplified cross-sectional view of a substrate heater 20 according to an embodiment of the invention. Heater 20 includes a ceramic (e.g., AlN, BN, SiC, SiN) substrate support 22 with an RF electrode 24 and resistive heating element 26 embedded therein along with a shaft or pedestal 28. Heating element 26 is the primary heat source for the substrate support and can be a resistive heating coil laid out in a two dimensional pattern slightly underneath the substrate support surface that is designed to provide generally uniform heating at the substrate support surface across the entire footprint of the substrate support. Pedestal 28, which can be made from the same ceramic material as substrate support 22, includes an interior cavity 30 that allows metal rods (not shown) to be extended within cavity 30 and coupled to electrode 24 and heating element 26 to provide power to each of the electrode and the heating element. As shown in FIG. 2, substrate heater 20 also includes a supplemental heater 40 that fits within cavity 30 of pedestal 28 to provide an additional source of heat in a central region of the substrate support. The supplemental heater can be any appropriate compact heat source that fits within cavity 30. In one particular embodiment, heater 40 is a ceramic block (e.g., aluminum nitride) having a second resistive heating element embedded therein that is independently controlled from heating element 26. In another embodiment, heater 40 includes a cartridge heater that slides into a cavity machined into the heater block.

Supplemental heater 40 fits within cavity 30 and abuts a bottom surface 32 of substrate support 22 in a position that provides good thermal contact between heater 40 and the substrate support. According to embodiments of the invention, heater 40 is a separate component from and not integrated with or bonded to substrate support 22. This allows the supplemental heater to be attached, detached and replaced as may be needed over the life of the substrate processing tool. Additionally, not bonding the two components together in a fixed manner reduces or eliminates the chances of cracking at the interface between the surface 32 and supplemental heater 40 due to stresses associated with a difference in coefficients of thermal expansion between heater 40 and substrate support 22. Some embodiments of the invention include a biasing mechanism (not shown in FIG. 2) that forces heater 40 in thermal contact with the substrate support as described below and that also allows the supplemental heater to be readily disengaged when needed.

When heater 20 is positioned within a substrate processing chamber, cavity 30 is isolated from the substrate processing region (not shown) of the chamber. Generally cavity 30 is under atmospheric pressure while the substrate processing region is evacuated to a subatmospheric or near vacuum pressure. Thus, heater 40 is not exposed to the environment within the processing chamber which is often corrosive. While not shown in FIG. 2, in one particular embodiment heater 40 includes four terminals that run through shaft 30 to the substrate support including two heater terminals, an RF terminal and a thermocouple terminal.

Embodiments of the invention allow for an additional degree of temperature control at the center of the substrate heater 20 so that a more uniform temperature can be seen by a substrate positioned on surface 21 across the entirety of the surface. As previously mentioned, without such an additional temperature control, the center region of the substrate may sometimes be cooler than the periphery which in turn may result in non-uniform processing of the substrate. For example, a center cold heater temperature profile will result in the deposition of a film having a higher center region during deposition of various SACVD silicon oxide thick or thin films among others. The inventors have determined that this issue is partly caused by a lack of heater coils in the center due to area taken up by required terminal connections to the heater and RF electrode. Even if, however, the heater coil design of heating element 26 is optimized so that a particular heater delivers a uniform temperature profile across the entire substrate surface at a particular temperature, for example, 480° C. or 540° C., the conductivity of AlN varies with temperature. Thus, as the heater set point decreases, AlN thermal conductivity of substrate support 22 and pedestal 28 increases thus increasing heat loss through the pedestal. Temperature difference between the center and periphery of even 0.5% (e.g., 500° C. at the periphery and 497.5° C. at the center) may result in unacceptable performance regarding film uniformity.

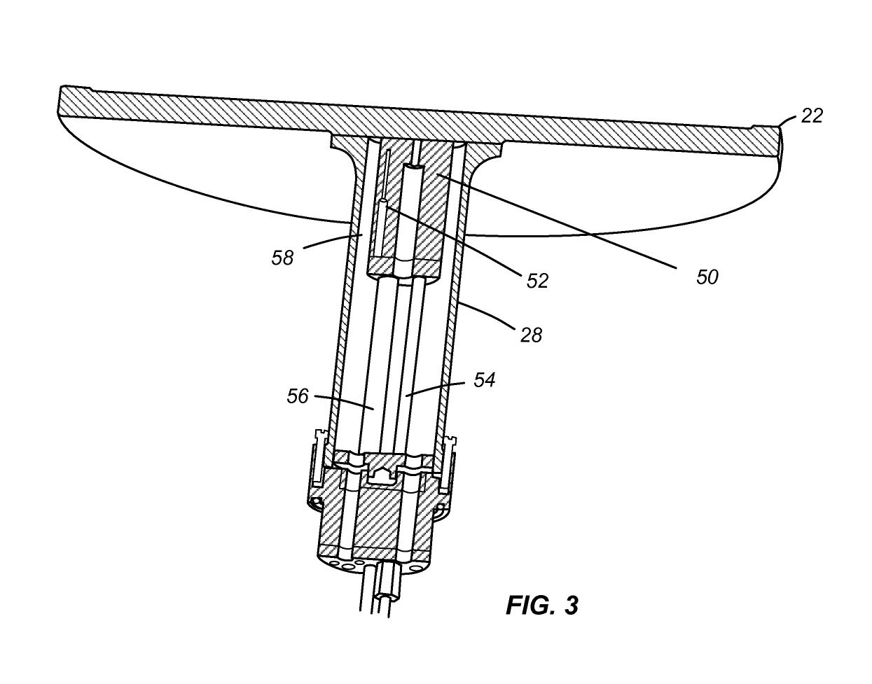

Embodiments of the invention compensate for the temperature drop in the center of the heater with supplemental heater 40 that is operatively coupled to the lower surface of the substrate support 22 within cavity 30 of the shaft 28 at interface 32. In one embodiment, shown in FIG. 3, the supplemental heater is a metal block 50 (e.g., aluminum, copper, nickel, or some combination or alloy thereof, etc.) that is in contact with the back surface of substrate support 22. An air gap 58 surrounds the periphery of heater block 50 so that the heater block is not in direct contact with the sidewalls of the pedestal shaft 28. Block 50 can be heated by any appropriate mechanism such as a resistive heater, a cartridge heater or the like. A thermocouple 52 monitors the temperature of the supplemental heater and the desired set point of heater block 50 can be set based on the whether or not temperature sensors (not shown) at various radii of substrate support 22 indicate there is a temperature difference at the substrate center versus the periphery. Terminal rods (e.g., nickel rods) run through ceramic tubes 54 and 56 to provide power to the embedded RF electrode and resistive heating element embedded within the substrate support 22 (neither of which is shown in FIG. 3). As mentioned above, substrate support 22 includes one or more of its own temperature sensors or thermocouples (not shown), different from thermocouple 52, that measures the temperature of the substrate support at different locations and are operatively coupled to a control element for the resistive heater (e.g., heater 26 shown in FIG. 2) that is the primary heat source to support 22.

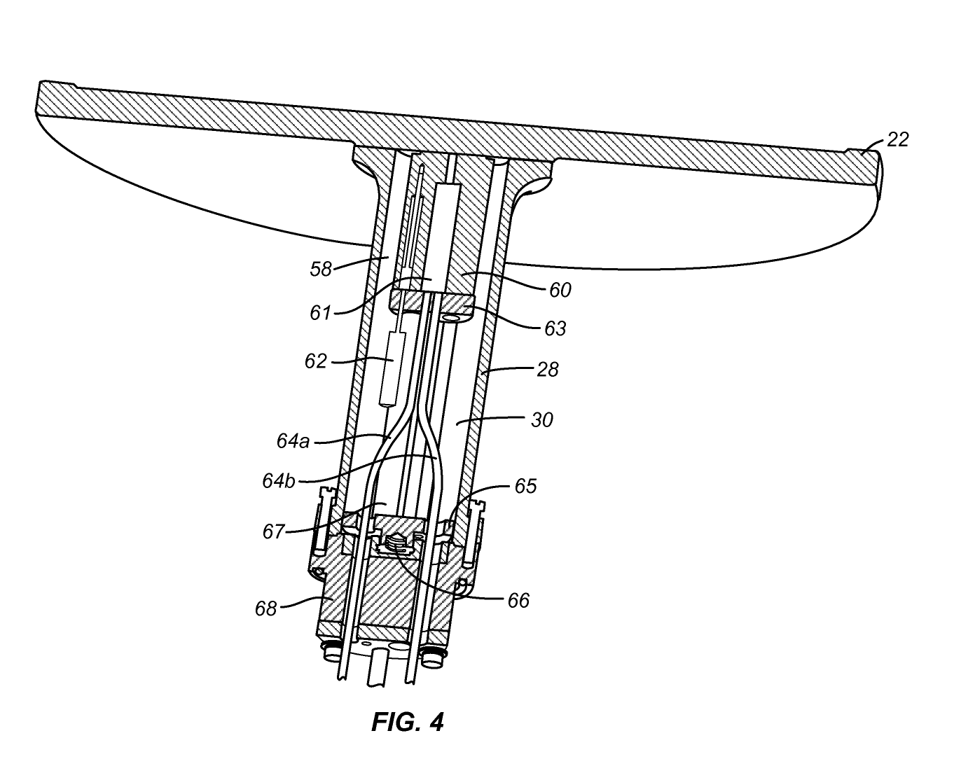

FIG. 4 is a simplified perspective view of another embodiment of the invention in which a supplemental heater 60 is fitted within the cavity 30 and operatively coupled to the lower surface of substrate support 22 within the cavity. As shown in FIG. 4, heater 60 is separated from an interior surface of shaft 28 by airgap 58. Heater 60 can be made from metal or a ceramic block, such as aluminum nitride, and includes a heater cartridge 61 that fits within a matching sized cavity. A thermocouple 62 monitors the temperature of the substrates support in a manner similar to that described above for thermocouple 52. Wires 64a, 64b provide power/signals to heater cartridge 61 and thermocouple 62. Heater cartridge 61 may include, for example, a standard resistive tungsten heater element.

A ceramic cap 63 can be secured to the end of heater 60 to hold heater cartridge 61 in place. Ceramic cap 63 can be made from an insulating ceramic material, such as aluminum oxide, that has less thermal conductivity than aluminum nitride to isolate components within shaft 30 and below heater 60 from its heat. Spaced apart from ceramic cap 63 is a high temperature ceramic (e.g., Al₂O₃) plate 65 that is operatively attached to a spring 66 near a center point of plate 65. In other embodiments, plate 65 may be made from a high temperature plastic or similar material.

One or more ceramic tubes 67 are positioned between plate 65 and cap 63 that allow the heater and RF terminals to be run through it to substrate support 22. Spring 66 biases the assembly of plate 65, tube(s) 67 and cap 63 so that, in operation, an upper surface of heater 60 is in thermal contact with the lower surface of substrate support 22. Spring 66 is positioned against an aluminum heater base plate 68 that is fixedly attached to pedestal 28.

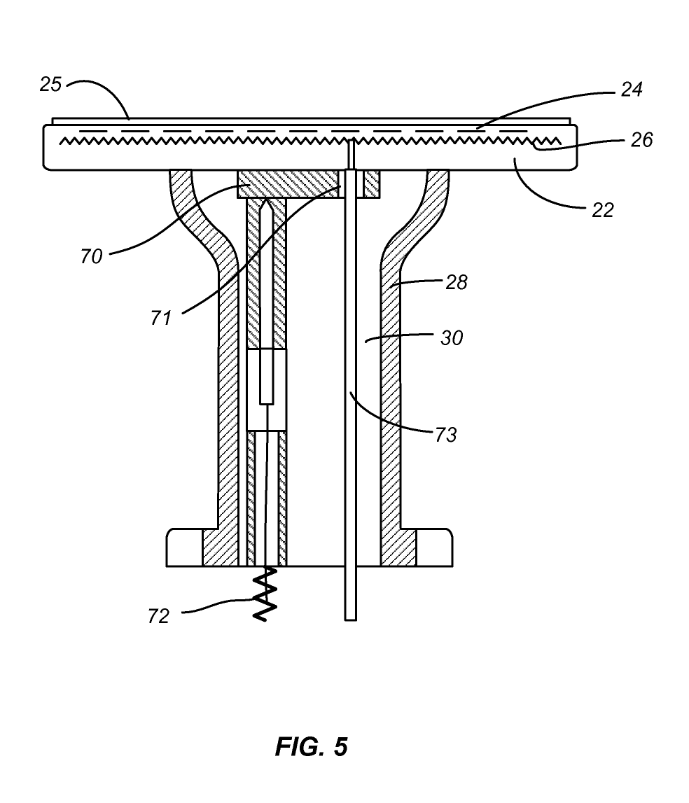

In another embodiment shown in FIG. 5, a supplemental heater 70 is positioned within the cavity 30 of a pedestal 28 and coupled to a spring-loaded mechanism 72 that allows heater 70 to be moved between a first position in which the heater is operatively engaged with the substrate support when additional heat control is desired or moved into a second position in which heater 70 is not in physical contact with the substrate support. Heater 70 includes one or more holes 71 through which terminal rods 73 (e.g., terminal rods for electrode 24 and RF heater 26) extend. Holes 71 allow heater 70 to slide up and down within the pedestal cavity. If desired, corrugated foil (e.g., Al, Cu, BeCu, etc.) or a ceramic foil or a similar component can be positioned between the interface of heater 70 (as well as heaters 40, 50, 60 or 80 shown in other embodiments) and the substrate support to effect heat transfer between the two bodies.

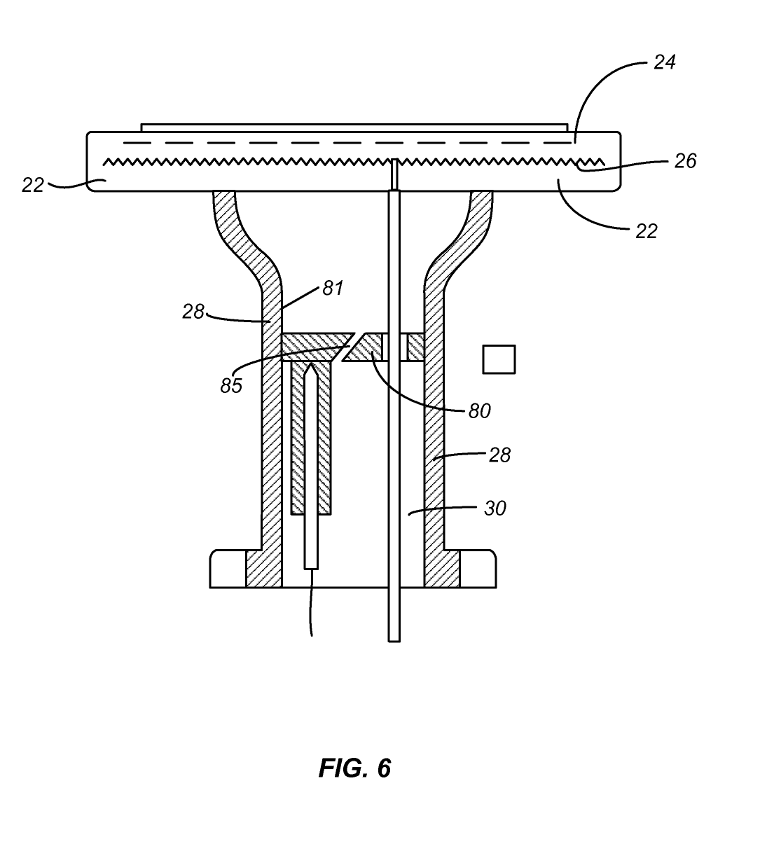

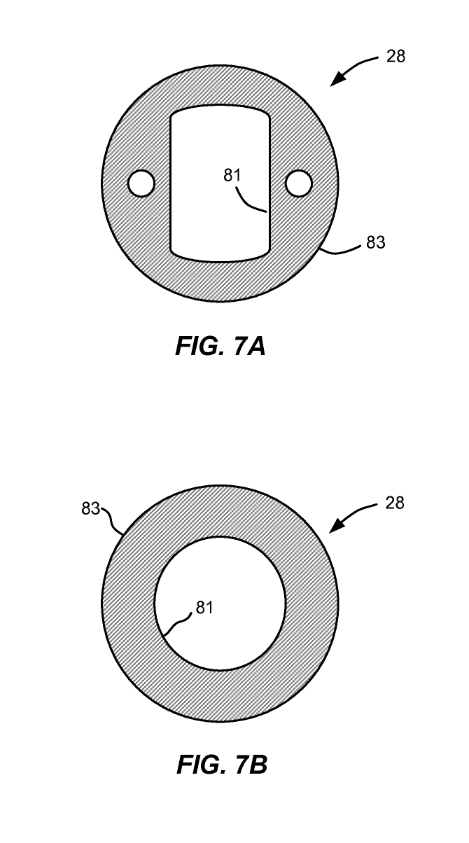

In still another embodiment shown in FIG. 6, a supplemental heater 80 is operatively coupled to a spring so that the heater can be engaged with an inner surface 81 of pedestal shaft 28, which is coupled to the bottom of the substrate support 22. To engage surface 81, heater 80 can be expanded radially by separating along a line 85. Once engaged, heat from heater 80 is transferred through shaft 28 to an annular area at the bottom of support 22. As shown in FIG. 7A, which is a simplified cross-sectional view of shaft 28, in some embodiments the cross section of shaft 28 is circular at an outer surface 83, but has a rectangular, rounded rectangular or oval shape at the inner surface 81. Such a shape, which is non-symmetric with respect to a circular substrate, is particularly useful when substrate support 22 includes a vacuum chuck (not shown) that is operatively coupled to vacuum lines 84. Heater 80 can be designed to compensate for the non-symmetric shape by providing a higher temperature at the portions of shaft 28 that have less surface area contact with the bottom of substrate support 22 than other areas of shaft 28. In other embodiments, both the outer and inner surfaces of shaft 28 have a circular cross section as shown in FIG. 7B and are thus symmetric with respect to a circular substrate being processed on support 22.

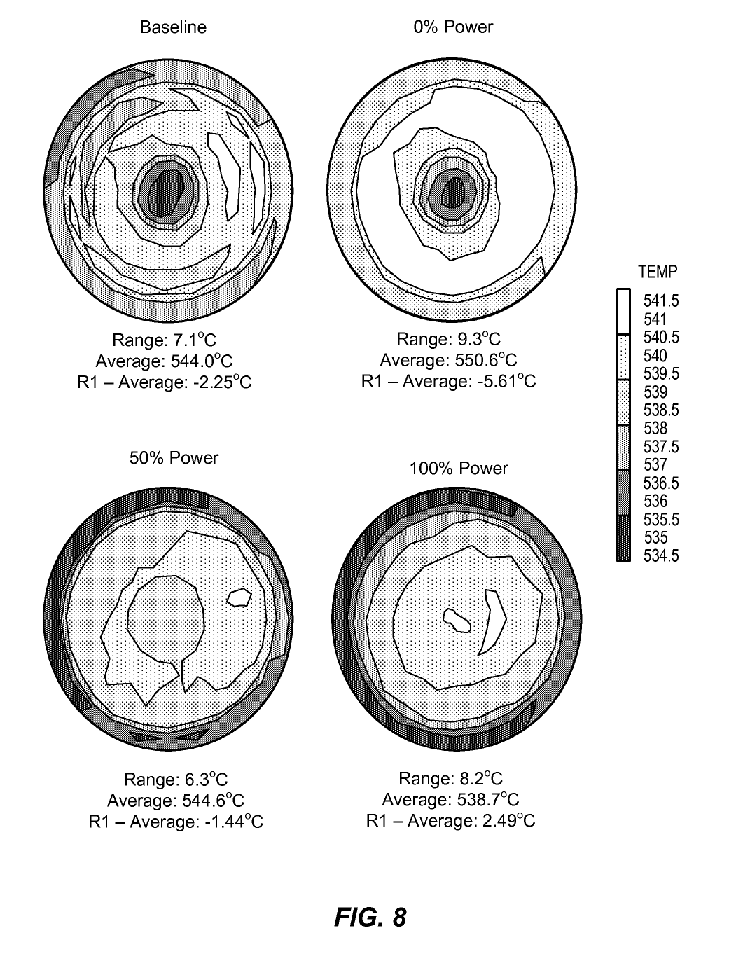

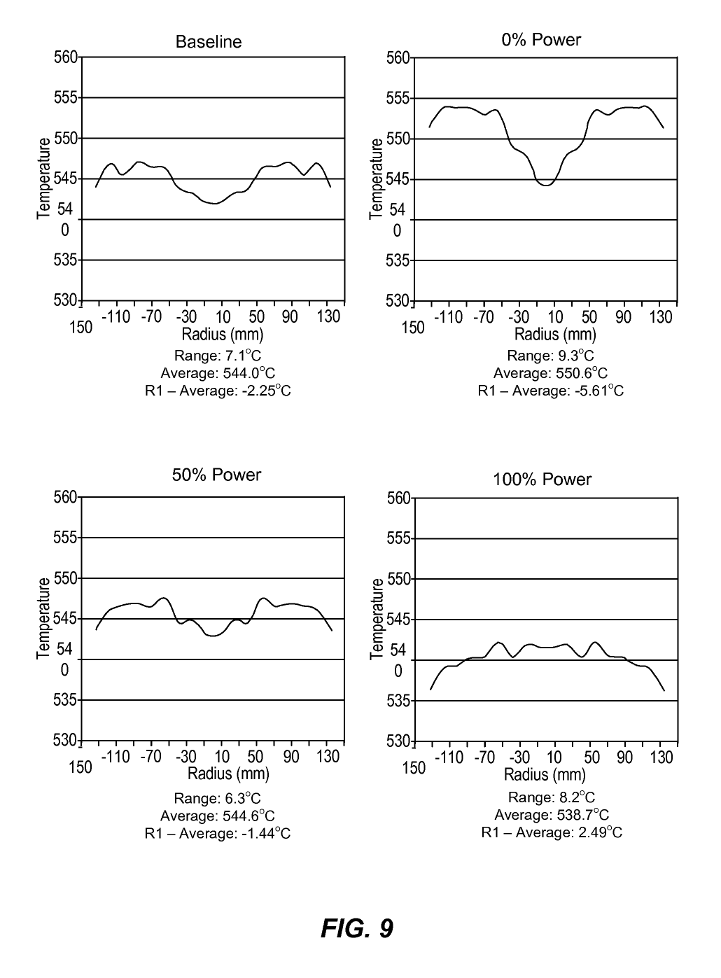

FIGS. 8 and 9 depict the results of tests that demonstrate the effectiveness of one particular embodiment of the present invention. Specifically, FIG. 8 shows that embodiments of the invention can be used to improve temperature uniformity over the surface of a wafer being processed on a substrate heater according to the present invention as compared to a previously known heater (the “baseline” test). Note, at 0% power, the temperature uniformity for the particular 550° C. process is worse than the previously known heater because the heater acts as a heat sink transferring heat away from the center of the wafer which is already cooler than the periphery at 550° C. in this heater design. As the supplemental heater is powered at 50% though, the average temperature difference drops and temperature is more uniform across the substrate with the techniques of the present invention than without. FIG. 9 shows the actual temperature for the tested power levels depicted in FIG. 8 measured at different radii of the substrate.

In some instances a substrate support designs may have a center temperature that is actually hotter than the periphery at some or all temperature ranges. Embodiments of the invention can improve uniformity for these substrate supports as well by not powering the heater within the supplemental heater or by driving the supplemental heater at a lower set point than the substrate temperature. In such situations, the supplemental heater, which has a relatively large mass, acts as a heat sink drawing heat away from the center of the substrate thus cooling the center of the substrate relative to the periphery.

What is claimed is:

1. A substrate heater comprising:
a substrate support having a substantially flat upper surface for supporting a substrate during substrate processing;
a resistive heater embedded within the substrate support;
a heater shaft coupled to a back surface of the substrate support, the heater having an interior cavity that extends along its longitudinal axis and ends at a bottom central surface of the substrate support;
a supplemental heater, separate from the ceramic substrate support, positioned within the interior cavity of the heater shaft in thermal contact with a portion of the bottom central surface of the substrate support such that the supplemental heater can alter the temperature of a central area of the upper surface of the substrate support; and
a biasing mechanism operatively coupled to bias the supplemental heater into thermal contact with the portion of the bottom central surface of the substrate support.

2. The substrate heater set forth in claim 1 wherein the supplemental heater includes a first cavity in which a cartridge heater can be inserted and a second cavity in which a thermocouple can be inserted.

3. The substrate heater set forth in claim 1 wherein the substrate support comprises a ceramic material.

4. The substrate heater set forth in claim 1 wherein the biasing mechanism comprises a spring.

5. The substrate heater set forth in claim 4 wherein the biasing mechanism further comprises a biasing plate and a ceramic tube positioned between the biasing plate and the heater, and wherein force from the spring is transferred to the supplemental heater through the biasing plate and the ceramic tube.

6. The substrate heater set forth in claim 1 wherein an air gap is formed around the supplemental heater between an interior surface of the heater shaft that defines the cavity and an outer peripheral surface of the supplemental heater.

7. The substrate heater set forth in claim 1 further comprising:
a thermocouple operatively coupled to measure a temperature of the substrate support;
an RF electrode embedded within the substrate support; and
wherein the supplemental heater comprises a ceramic block having a bottom surface and a top surface that is in thermal contact with a portion of the bottom central surface of the substrate support; and a plurality of through holes extend from the bottom surface to the top surface to allow a first terminal to be operatively coupled to the resisitive heater, a second terminal to be operatively coupled to the RF electrode and a third terminal to be operatively coupled to the thermocouple.

8. The substrate heater set forth in claim 7 wherein the ceramic block further includes first cavity and second longitudinally aligned cavities that do not extend through the top surface, wherein the first cavity is sized to accept a cartridge heater and the second cavity is sized to accept a thermocouple adapted to measure a temperature of the supplemental heater.

9. A substrate heater comprising:
a ceramic substrate support having a substantially flat upper surface for supporting a substrate during substrate processing;
a resistive heater embedded within the substrate support and laid out in a two dimensional pattern that is adapted to heat the upper surface of the substrate support in a generally uniform manner;
a heater shaft coupled to a back surface of the substrate support, the heater that defines an interior cavity that extends along its longitudinal axis and ends at a bottom central surface of the substrate support;
a supplemental heater detachable from the ceramic substrate support and positioned within the interior cavity of the heater shaft, wherein an air gap is formed around the supplemental heater between an interior surface of the heater shaft that defines the cavity and an outer peripheral surface of the supplemental heater; and
a biasing mechanism operatively coupled to force the supplemental heater in thermal contact with a portion of the bottom central surface of the substrate support such that the supplemental heater can alter the temperature of a central area of the upper surface of the substrate support.

10. The substrate heater set forth in claim 9 wherein the biasing mechanism comprises a spring.

11. A substrate heater comprising:
a ceramic substrate support having a substantially flat upper surface for supporting a substrate during substrate processing;
a resistive heater embedded within the substrate support and laid out in a two dimensional pattern that is adapted to heat the upper surface of the substrate support in a generally uniform manner;
a heater shaft coupled to a back surface of the substrate support, the heater that defines an interior cavity that extends along its longitudinal axis and ends at a bottom central surface of the substrate support;
a supplemental heater separate from the ceramic substrate support and positioned within the interior cavity of the heater shaft; and
a biasing mechanism operatively coupled to force the supplemental heater in thermal contact with an interior surface of the heater shaft that defines the cavity.
